(19) United States
(12) Patent Application Publication
(10) Pub. No.: US 2012/0016872 A1
(43) Pub. Date: Jan. 19, 2012

(54) METHODS AND APPARATUSES FOR USE IN GENERATING AN ENCODED ROUTEABILITY GRAPH DESCRIPTION

(75) Inventors: Behrooz Khorashadi, Mountain View, CA (US); Rajarshi Gupta, Sunnyvale, CA (US); Saumitra Mohan Das, San Jose, CA (US)

(73) Assignee: QUALCOMM Incorporated, San Diego, CA (US)

(21) Appl. No.: 13/180,153

(22) Filed: Jul. 11, 2011

Related U.S. Application Data
(60) Provisional application No. 61/363,980, filed on Jul. 13, 2010.

(51) Int. Cl. G06F 17/30

(52) U.S. Cl. 707/724; 707/E17.018

(57) ABSTRACT

Methods and apparatuses are provided that may be implemented in one or more electronic devices to generate an encoded routeability graph description corresponding to a diagram of a structure. The methods and apparatuses may, for example, implement a reduction process to reduce a number of grid points within an encoded routeability graph description, or which may be otherwise used to generate an encoded routeability graph description.

### CLAIM OF PRIORITY UNDER 35 U.S.C. §119

This application claims priority under 35 USC 119 to U.S. Provisional Application Ser. No. 61/363,980, filed Jul. 13, 2010, and entitled, “Map Reduction”, which is assigned to the assignee hereof and which is incorporated herein by reference.

### CROSS REFERENCE TO RELATED APPLICATIONS

The subject matter disclosed herein relates to U.S. Patent Application Ser. No. (Attorney Docket No. 102029), titled “INDOOR LIKELIHOOD HEATMAP,” assigned to the assignee of the present application and filed on the same day as the present application, and U.S. Provisional Application No. 61/363,984, filed 13 Jul. 2010, and entitled “Movement Heatmap,” assigned to the assignee of the present application.

### BACKGROUND

1. Field

The subject matter disclosed herein relates to electronic devices, and more particularly to methods and apparatuses for use in generating an encoded routeability graph description for use with an electronic diagram (e.g., floor plans, maps, etc.) pertaining to at least a portion of a structure.

2. Information

The Global Positioning System (GPS) represents one type of Global Navigation Satellite System (GNSS), which along with other types of satellite positioning systems (SPS) provide or otherwise support signal-based position location capabilities (e.g., navigation functions) in mobile devices, and particularly in outdoor environments. However, since some satellite signals may not be reliably received and/or acquired by a mobile device within an indoor environment or other like mixed indoor/outdoor environments, different techniques may be employed to enable position location services.

For example, mobile devices may attempt to obtain a position fix by measuring ranges to three or more terrestrial transmitters (e.g., wireless access points, beacons, cell towers, etc.) which are positioned at known locations. Such ranges may be measured, for example, by obtaining a MAC ID address from signals received from such transmitters and obtaining range measurements to the transmitters by measuring one or more characteristics of signals received from such transmitters such as, for example, signal strength, a round trip delay time, etc.

These and other like position location and navigation techniques tend to be of further benefit to a user if presented with certain mapped features. For example, mapped features may relate to or otherwise identify certain physical objects, characteristics, or points of interest within a building or complex, etc. Thus, in certain instances, an indoor navigation system may provide a digital electronic map to mobile device upon entering a particular indoor area. Such a map may show indoor features such as doors, hallways, entry ways, walls, etc., points of interest such as bathrooms, pay phones, room names, stores, etc. Such a digital electronic map may be stored at a server to be accessible by a mobile device through selection of a URL, for example. By obtaining and displaying such a map, a mobile device may overlay a current location of the mobile device (and user) over the displayed map to provide the user with additional context.

Accordingly, with the plethora of information that may be provided to and/or otherwise used by a mobile device, there is a continuing desire to reduce the amount of data and/or the size of data files that may need to be transmitted, stored, and/or processed by the various devices and communications resources.

### SUMMARY

Various methods and apparatuses are provided that may be implemented in one or more electronic devices to generate an encoded routeability graph description corresponding to a diagram of a structure.

In accordance with one aspect, an example method of generating an encoded routeability graph description may be implemented which comprises projecting grid points over a diagram of an indoor area, the diagram indicating at least some route obstructions in the indoor area; ranking the grid points based, at least in part, on distances between the grid points and the route obstructions; and selectively merging grid points with locations of higher ranking neighboring grid points based, at least in part, on an absence of route obstructions between the locations and grid points which are neighboring the merged grid points.

In accordance with another aspect, an example method may comprise, with a computing device: assigning a set of grid points to locations on a diagram, wherein at least a portion of the diagram is indicative of at least one feature within a portion of a structure; ranking at least a portion of the grid points based, at least in part, on proximities of the locations to the at least one feature; and reducing the set of grid points by selectively merging a first grid point with a second grid point that is adjacent to the first grid point and which has a higher ranking than the first grid point, and provided that: (1) there are no route obstructions in the diagram between the second grid point and any other grid points that are adjacent to the first grid point, and (2) there would have been no route obstructions in the diagram between the second grid point and any grid points that were previously merged with the first grid point.

In accordance with still another aspect, an example apparatus for use in generating an encoded routeability graph description may be implemented which comprises: means for projecting grid points over a diagram of an indoor area, the diagram indicating at least some route obstructions in the indoor area; means for ranking the grid points based, at least in part, on distances between the grid points and the route obstructions; and means for selectively merging grid points with locations of higher ranking neighboring grid points based, at least in part, on an absence of route obstructions between the locations and grid points which are neighboring the merged grid points.

In accordance with yet another aspect, an example apparatus for use in a computing device may be implemented which comprises: means for assigning a set of grid points to locations on a diagram, wherein at least a portion of the diagram is indicative of at least one feature within a portion of a structure; means for ranking at least a portion of the grid points based, at least in part, on proximities of the locations to the at least one feature; and means for reducing the set of grid points by selectively merging a first grid point with a second grid point that is adjacent to the first grid point and which has a higher ranking than the first grid point, and provided that: (1) there are no route obstructions in the diagram between the second grid point and any other grid points that are adjacent to the first grid point, and (2) there would have been no route obstructions in the diagram between the second grid point and any grid points that were previously merged with the first grid point.

In accordance with one further aspect, an example device for generating an encoded routeability graph description may be implemented, which comprises memory and at least one processing unit. For example, the processing unit may project grid points over a diagram of an indoor area, the diagram indicating at least some route obstructions in the indoor area; rank the grid points based, at least in part, on distances between the grid points and the route obstructions; and selectively merge grid points with locations of higher ranking neighboring grid points based, at least in part, on an absence of route obstructions between the locations and grid points which are neighboring the merged grid points.

In accordance with still other aspects, an example device may be implemented which comprises memory and at least one processing unit. For example, at processing unit may: assign a set of grid points to locations on a diagram, wherein at least a portion of the diagram is indicative of at least one feature within a portion of a structure; rank at least a portion of the grid points based, at least in part, on proximities of the locations to the at least one feature; and reduce the set of grid points by selectively merging a first grid point with a second grid point that is adjacent to the first grid point and which has a higher ranking than the first grid point, and provided that: (1) there are no route obstructions in the diagram between the second grid point and any other grid points that are adjacent to the first grid point, and (2) there would have been no route obstructions in the diagram between the second grid point and any grid points that were previously merged with the first grid point.

In accordance with another aspect, an example article of manufacture may be implemented, e.g., for use in generating an encoded routeability graph description. For example, an article may comprise a non-transitory computer readable medium having stored therein computer implementable instructions executable by a processing unit to: project grid points over a diagram of an indoor area, the diagram indicating at least some route obstructions in the indoor area; rank the grid points based, at least in part, on distances between the grid points and the route obstructions; and selectively merge grid points with locations of higher ranking neighboring grid points based, at least in part, on an absence of route obstructions between the locations and grid points which are neighboring the merged grid points.

In accordance with still another aspect, an example an example article of manufacture may be implemented which comprises a non-transitory computer readable medium having stored therein computer implementable instructions executable by a processing unit to: assign a set of grid points to locations on a diagram, wherein at least a portion of the diagram is indicative of at least one feature within a portion of a structure; rank at least a portion of the grid points based, at least in part, on proximities of the locations to the at least one feature; and reduce the set of grid points by selectively merging a first grid point with a second grid point that is adjacent to the first grid point and which has a higher ranking than the first grid point, and provided that: (1) there are no route obstructions in the diagram between the second grid point and any other grid points that are adjacent to the first grid point, and (2) there would have been no route obstructions in the diagram between the second grid point and any grid points that were previously merged with the first grid point.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating a computing and communication environment, in which an encoded routeability graph description may be generated, transmitted, stored, and/or otherwise processed, in accordance with an example implementation.

FIG. 2 is a schematic block diagram illustrating certain features of a computing device that may generate an encoded routeability graph description, in accordance with an example implementation.

FIG. 3 is a schematic block diagram illustrating certain features of a mobile device that may use an encoded routeability graph description, in accordance with an example implementation.

FIG. 4 is an illustrative set of diagrams showing at least a portion of a diagram of a structure and an assigned set of interconnected grid points of a type that may be used in generating an encoded routeability graph description, in accordance with an example implementation.

FIG. 5 is an illustrative diagram showing a grid point and its proximity (e.g., distance measurements) to certain features (objects, obstacles, etc.) of a diagram of a structure, in accordance with an example implementation.

FIG. 6 is an illustrative diagram showing a grid point and its proximity (e.g., grid point hops) to certain features (objects, obstacles, etc.) of a diagram of a structure, in accordance with an example implementation.

FIG. 7 is an illustrative diagram showing grid points assigned to locations in a diagram of a structure and a ranked list based on proximity determinations, in accordance with an example implementation.

FIG. 8 is an illustrative diagram similar to FIG. 7 showing that certain grid points may be selectively merged, in accordance with an example implementation.

FIG. 9 is an illustrative diagram similar to FIG. 8 showing that certain additional grid points may be selectively merged, for example, through an iterative process, in accordance with an example implementation.

FIG. 10 is an illustrative diagram similar to FIG. 9 showing that all of the grid points that may be selectively merged have been selectively merged, for example, through an iterative process leaving a reduced set of grid points which may be used to generate a routeability graph, in accordance with an example implementation.

FIG. 11 is a detailed diagram showing a set of grid points assigned to locations in a diagram of a floor of a v-shaped office building prior to a reduction process, in accordance with an example implementation.

FIG. 12 is a detailed diagram as in FIG. 11, showing a reduced set of grid points in a diagram of a floor of a v-shaped office building following a reduction process, in accordance with an example implementation.

FIG. 13 is a flow diagram illustrating an example method that may be implemented in whole or part in with a computing device and/or with a mobile device to generate all or part of an encoded routeability graph description, in accordance with an implementation.

FIG. 14 is a flow diagram illustrating another example method that may be implemented in whole or part in with a computing device and/or with a mobile device to generate all or part of an encoded routeability graph description, in accordance with an implementation.

### DETAILED DESCRIPTION

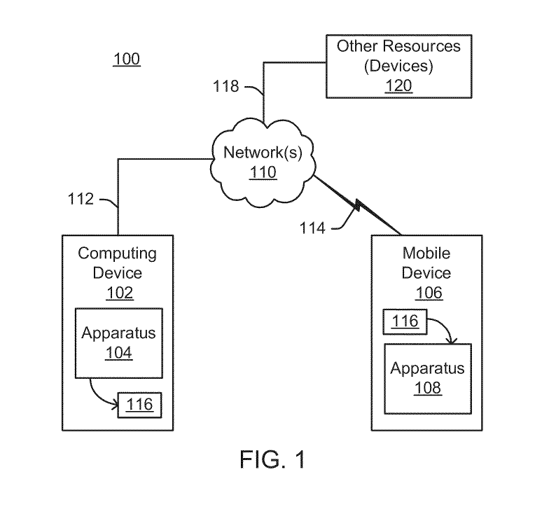

FIG. 1 is a schematic block diagram illustrating a computing and communication environment 100, in which an encoded routeability graph description 116 may be generated, transmitted, stored, and/or otherwise processed, in accordance with an example implementation.

Example environment 100 may comprise a computing device 102 having an apparatus 104 for use in generating all or part of encoded routeability graph description 116. As described in greater detail below, apparatus 104 may, for example, obtain a diagram (e.g., one or more electronic files relating to a floor plan, map, CAD drawing, etc.) for a structure that includes an indoor area that may be navigated in some manner by a user of a mobile device 106. A diagram may indicate at least one feature that may affect a route within the structure. For example, certain features may indicate various types of route obstructions present within an indoor area. Apparatus 104 may, for example, assign (e.g., project, overlay, relate, etc.) a set of grid points to at a portion of a diagram of an indoor area, and rank the grid points based, at least in part, on their proximity (e.g., distance) to one or more features. Apparatus 104 may, for example, selectively merge certain grid points to reduce the set of grid points. Thus, for example, in certain implementations, apparatus 104 may selectively merge grid points with locations of higher ranking neighboring grid points based, at least in part, on an absence of route obstructions between the locations and grid points which are neighboring the merged grid points. A resulting reduced set of grid points may be used to generate, or may comprise, encoded routeability graph description 116, for example.

As shown, computing device 102 may be connected to one or more wired and/or wireless network(s) 110 via a communication link 112. A mobile device 106 may, for example, be coupled to network(s) 110 via a wireless communication link 114. As such, an encoded routeability graph description 116 may be transmitted or otherwise provided by computing device 102 to mobile device 106. Mobile device 106 may, for example, comprise an apparatus 108 which may generate, obtain, store, transmit, and/or otherwise process all or part of an encoded routeability graph description 116. Network(s) 110 may, for example, be further connected to one or more other resources (devices) 120, e.g., via communication link 118. In certain example implementations, computing device 102 and/or mobile device 106 may obtain all or part of an electronic diagram for a structure from other resources (devices) 120.

The term “structure” may, for example, apply to (all or part of) one or more natural and/or man-made physical arrangements of object(s), the knowledge of which may be of use to a user of mobile device 106. For example, a structure may comprise one or more buildings or a portion thereof. A “feature” may, for example, identify an object or obstacle (e.g., a wall, a door, an elevator, a staircase, a statue, etc.), an entity and/or service (e.g., a business, a taxi stand, a restroom, a doctor's office, a lost and found department, a security station, etc.), and/or any other navigational, location based service characteristic which may be identified via representative data in one or more files of an electronic map. In certain instances, for example, a feature may represent something to navigate around (e.g., such as a route obstacle), navigate towards or through (e.g., a doorway, an elevator, etc.), or possibly navigate away from (e.g., a staircase,). Of course these are simply a few examples and, as with all of the examples presented herein, claimed subject matter is not necessarily intended to be so limited.

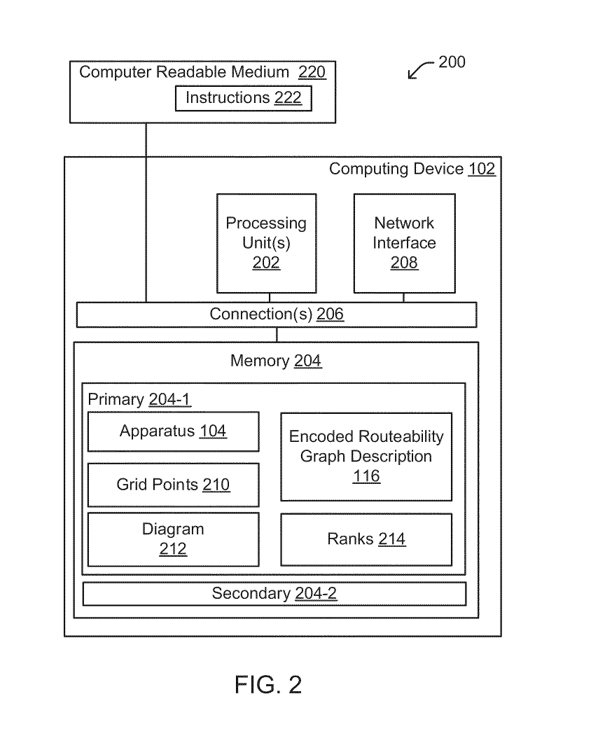

Reference is made next to FIG. 2, which is a schematic block diagram illustrating certain features of computing device 102, for example as in FIG. 1, in accordance with an implementation.

As illustrated computing device 102 may comprise one or more processing units 202 to perform data processing (e.g., in accordance with the techniques provided herein) coupled to memory 204 via one or more connections 206. Processing unit(s) 202 may, for example, be implemented in hardware or a combination of hardware and software. Processing unit(s) 202 may, for example, be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 204 may be representative of any data storage mechanism. Memory 204 may include, for example, a primary memory 204-1 and/or a secondary memory 204-2. Primary memory 204-1 may comprise, for example, a random access memory, read only memory, etc. While illustrated in this example as being separate from the processing units, it should be understood that all or part of a primary memory may be provided within or otherwise co- located/coupled with processing unit(s) 202, or other like circuitry within computing device 102. Secondary memory 204-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, a (non-transitory) computer readable medium 220. Memory 204 and/or computer readable medium 220 may comprise computer-implementable instructions 222 for certain example techniques as provided herein.

As illustrated in FIG. 2, as various times memory 204 may store certain signals representing data and/or computer-implementable instructions for certain example techniques as provided herein. For example, memory 204 may store data and/or computer-implementable instructions for apparatus 104. By way of example, memory 204 may at various times store representative data for various grid points 210, one or more diagrams 212 or portions thereof, all or part of an encoded routeability graph description 116, and/or various ranks 214, e.g., associated with grid points 210.

As shown, computing device 102 may, for example, comprise a network interface 208. Network interface 208 may, for example, provide a capability to receive and/or transmit wired and/or wireless signals, e.g., to communicate via network(s) 110 (FIG. 1).

In certain example implementations, computing device 102 may take the form of a server or other like device. In certain example implementations, computing device 102 may take the form of a wireless network element, or other location based service element. In certain example implementations, computing device 102 may take the form of a portion of a cloud computing configuration. In certain example implementations, computing device 102 may take the form of a wireless access point or other like local area computing resource.

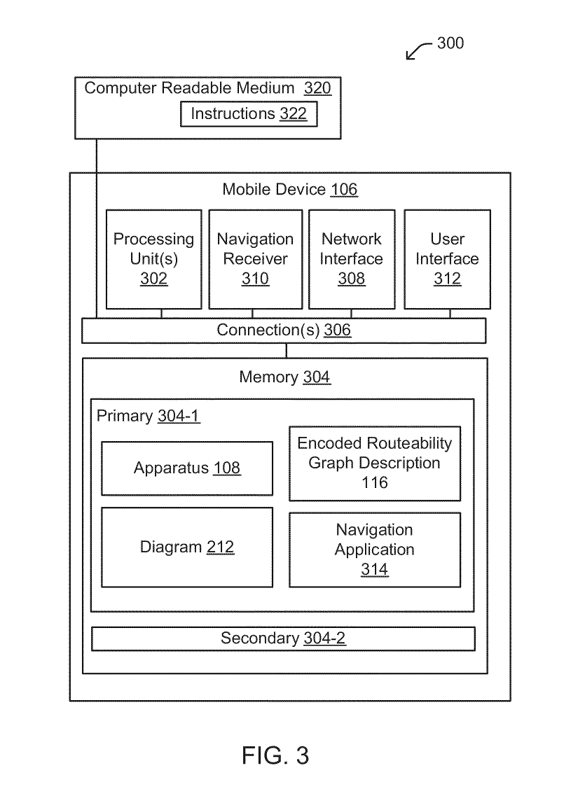

Reference is made next to FIG. 3, which is a schematic block diagram illustrating certain features of mobile device 106, for example as in FIG. 1, in accordance with an implementation.

As illustrated mobile device 106 may comprise one or more processing units 302 to perform data processing (e.g., in accordance with the techniques provided herein) coupled to memory 304 via one or more connections 306. Processing unit(s) 302 may, for example, be implemented in hardware or a combination of hardware and software. Processing unit(s) 302 may, for example, be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 304 may be representative of any data storage mechanism. Memory 304 may include, for example, a primary memory 304-1 and/or a secondary memory 304-2. Primary memory 304-1 may comprise, for example, a random access memory, read only memory, etc. While illustrated in this example as being separate from the processing units, it should be understood that all or part of a primary memory may be provided within or otherwise co- located/coupled with processing unit(s) 302, or other like circuitry within mobile device 106. Secondary memory 304-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, a (non-transitory) computer readable medium 320. Memory 304 and/or computer readable medium 320 may comprise computer-implementable instructions 322 for certain example techniques as provided herein.

As illustrated in FIG. 3, as various times memory 304 may store certain signals representing data and/or computer-implementable instructions for certain example techniques as provided herein. For example, memory 304 may store data and/or computer-implementable instructions for apparatus 108. By way of example, memory 304 may at various times store representative data for an encoded routeability graph description 116, one or more diagrams 212 or portions thereof, and possibly a navigation application 314. In certain instances, memory 304 may also comprise similar instructions and/or data as shown in the example computing device 102 of FIG. 2. For example, in certain implementations, mobile device 106 may perform all or part of the functions that may be associated with apparatus 104 in computing device 102.

As shown, mobile device 106 may, for example, comprise a network interface 308. Network interface 308 may, for example, provide a capability to receive and/or transmit wired and/or wireless signals, e.g., to communicate via network(s) 110 (FIG. 1).

As shown, mobile device 106 may, for example, comprise a navigation receiver 310, which may provide position location and/or other navigation services based on wireless signals transmitted by various transmitting devices. For example, navigation receiver 310 may comprise an SPS receiver capable of receiving and processing one or more Global Navigation Satellite Systems (GNSSs), or other like satellite and/or terrestrial locating services, such as, e.g., one or more location based services (LBSs) which may be provided, at least in part, by a cellular network, a WiFi network, etc.

As shown, mobile device 106 may comprise one or more user interfaces 312. For example user interface 312 may be representative of one or more user input and/or user output devices. Thus, for example, user interface 312 may comprise a keypad, a touch screen, various buttons, various indicators, a display screen, a speaker, a microphone, a projector, a camera, etc.

Mobile device 106 is representative of any electronic device that may be moved about within environment 100. For example, mobile device 106 may comprise a hand-held computing and/or communication device, such as, a mobile telephone, smart phone, lap top computer, tablet computer, navigation device, and/or the like. In certain example implementations, mobile device 106 may be part of a circuit board, an electronic chip, etc.

It should be understood that mobile device 106 may also or alternatively comprise one or more other circuits, mechanisms, etc., (not shown) that may be of use in performing one or more other functions or capabilities, and/or supportive of certain example techniques as provided herein.

Computing device 102 and/or mobile device 106 may, for example, be enabled (e.g., via one or more network interfaces) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATS) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, 1S-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

An electronic diagrams, such as, e.g., a digital map of an indoor space may, for example, be derived from a CAD or other like drawing or file. Thus, a CAD drawing may show rooms and hallways formed by walls, doorways, etc. Once the CAD drawing is transformed to a particular format usable as a digital map, the digital map may be electronically stored for access by mobile devices as discussed above.

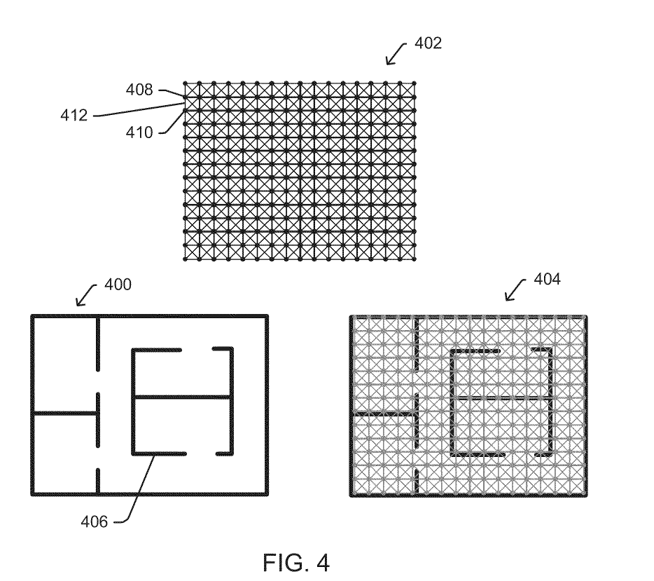

By way a simple example, FIG. 4 shows a diagram 400 of a structure having a feature (wall) 406 therein, an example set of interconnected grid points 402, and an illustrated version of an assigned set of interconnected grid points 404 that has been projected on diagram 400. In this example, the grid points (shown as round dots) are evenly spaced apart and arranged in uniform two- dimensional array with vertical, horizontal and diagonal interconnections between adjacent grid points. Consequently, at least in this example, a grid point may have up to eight different “adjacent” (connected neighbor) grid points. By way of example, a grid point (or node) 408 may be interconnected to and hence be a neighbor of a grid point (or node) 410, as illustrated by a line 412.

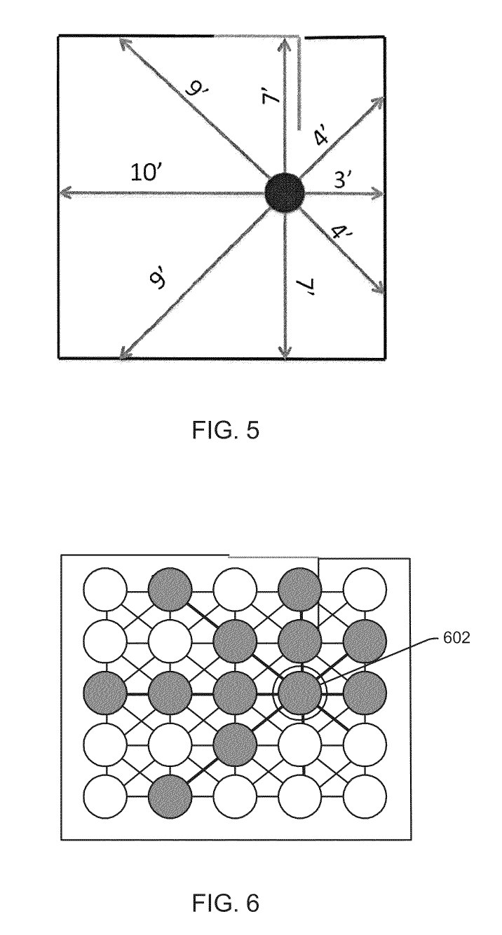

As illustrated in FIG. 5 and FIG. 6 and as described below, the interconnecting lines may, in certain instances, also represent directional axes or paths that may be followed from a location of a grid point on a diagram to a feature (e.g., a route obstacle) or possibly another grid point's location is reached to determine a proximity (e.g., distance, number of grid point hops, etc.). A determined proximity measurement may, for example, be used in ranking the grid point relative to the other grid points. It should be understood that, as with all of the example implementations presented herein, claimed subject matter is not necessarily limited to just these examples. Thus, in certain other implementations, a set of grid points may be arranged in some other uniform or non-uniform manner, interconnected in varying ways leading to various two or three dimensional shapes, etc. Indeed, in certain instances different sets or mixed sets of grid points may be used.

In one particular implementation, a set of grid of points may be projected over an area covered by a map of an indoor area such as a floor of an office building, shopping mall, school building, etc. Neighboring (adjacent) grid points may then be selectively connected by edges subject to features in the map to indicate possible direct transitions between locations of the neighboring points without obstruction (e.g., walls). Thus, for example, interconnected grid points may form “nodes” in a routeability graph for use in modeling movement of a mobile device in the indoor area.

In particular implementations, a location of a mobile device may be modeled as being placed at points along edges connecting neighboring nodes in the routeability graph described above. Likewise, transitions from an initial position to a subsequent position may be modeled to occur along edges of the routeability graph. In addition, a likelihood model may further characterize possible transitions of a mobile device from an initial position to a subsequent over a time period. In a particular example, a particle filtering model may establish a likelihood that a mobile device have a particular subsequent location, velocity and heading that is conditioned on an initial location, velocity and heading.

To provide sufficient granularity in certain example encoded routeability graph descriptions, grid points may be projected over an indoor area densely so that a routeability graph may be sufficiently granular to support particular applications. However, determining a routeability graph and/or transition probabilities for a dense population of grid points may be computationally intensive. Likewise, executing mobile applications to perform routing, particle filtering, etc., processing resources of a mobile device may be taxed by computing/evaluating detailed routes and/or a large number/high density of particles using particle filtering techniques. As such, there may be a need to provide sufficient granularity in routeability graphs and/or density of particles without over taxing processing resources.

In one embodiment, a particle filtering application (e.g., in a navigation application) may employ a “probability heatmap” which is used to express a likelihood that a path taken in the indoor area passes through particular grid points. For a large indoor area with a high density of grid points, it can be seen that determination of such a probability heat map is computationally intensive. In one implementation, a probability heat map provides a weight for each grid point expressing a likelihood that a path take in the indoor area passes through the grid point. As discussed below, these weights can be determined in a particular implementation by computing/determining a likely path between each pair of grid points and maintaining a count of instances where a grid point in an intermediate node in such a likely path. As also discussed below, likely paths may be determined using a reduced encoded routeability graph description.

According to an embodiment, an encoded routeability graph description having a reduced size may be produced from a dense population of grid points over an indoor area. Here, by reducing a number grid points from being nodes in an encoded routeability graph description, the encoded routeability graph description may be computed using fewer computing resources while still providing sufficient granularity for mobile applications of interest. In addition, an encoded routeability graph description may enable use of a reduced number of particles for particle filtering applications.

In a particular implementation, grid points may be first ranked based, at least in part, on a closest proximity (distance) along an axis to an obstruction. Grid points having a greater (minimum) distance to one or more features (e.g., route obstructions) may be ranked higher while grid points having a shorter (minimum) distance to one or more features may be ranked lower.

An example illustration of a proximity based on distance from a location of a grid point to a route obstruction (e.g., a wall in a room) is shown in FIG. 5 (not drawn to scale). As shown, in this example, distances are shown for eight straight paths extending outward from a point location in the middle of the drawn circle representing a grid point. Here, for example, the greatest distance to a route obstruction is ten feet along a left-hand horizontal axis, and a shortest distance to a route obstruction is three feet along a right-hand horizontal axis (as viewed). Notice that a distance of seven feet is shown for both an upper and a lower vertical axis, and more particularly in this example the upper vertical axis is measured to a feature (here, a doorway having a door) that may or may not be navigated through. In certain other instances, for example, if there were no door but instead there was another room or hallway, then the distance measured along the applicable axis may be based on a feature (e.g., route obstacle) within the other room or hallway, or even possibly beyond there.

In certain example implementations a node's or grid point's ranking may be based, at least in part, on a distance to the nearest building feature. As shown, for example, one may define a feature as anything that cannot be routed through and must be routed around. Some common examples may include walls, doors, certain building furniture, etc. As shown in FIG. 5, a nearest feature may be found by drawing expanding lines out from a node in multiple directions until one of them intersects with an applicable feature. Thus, in the example shown in FIG. 5, the illustrated grid point may be ranked as a “3” (e.g., based on the three foot shortest distance).

In certain instances, there may be several grid points (nodes) that have the same shortest proximity (e.g., distance or hops), and hence may have possibly equivalent ranks. In order to further distinguish these equivalent rankings, one may further consider one or more additional proximity measurements. For example, a secondary rank may be established and considered which may be based on a combined (or possibly a total) proximity measurement along two or more axis or paths. By way of example, for the grid point in FIG. 5, a secondary rank using all available distance measurements (e.g., as shown) may be “53” (e.g., based on the summation of the eight measurements). Thus, for example, a secondary rank may be used as a tie-breaker in the case of equivalent primary ranks.

Such a process may be extremely computationally expensive especially if such distance measurements are to be repeated for all of the grid points with locations within a large structure. As such, in certain implementations, various optimizations and heuristics may be used to get fast, but possibly lower accuracy proximity estimates.

One example may be to use the interconnected grid points to determine a rank based on grid point “hops”, e.g., as illustrated in the example in FIG. 6. In FIG. 6, a room with a doorway (with a door) is shown as having twenty five gird points or nodes located therein. Thus, for grid point 602 (circled), there are eight interconnected paths which may be followed. The longest path comprises three hops and the shortest path comprises one hop. Hence, a rank (primary) for grid point 602 may be “1”, e.g., based on the shortest path. A secondary rank for grid point 602 may be “11”, e.g., based on a summation of the total number of hops for the eight paths.

To reduce a set of grid points, one may selectively “merge” certain grid points. Thus, various merging rules may be used to reduce the number of grid points in a set of grid points through selective merging of grid points. For example, in certain implementations, certain grid points may be merged with locations of higher ranking neighboring grid points under certain conditions to allow for computation/determination of a reduced encoded routeability graph description 116 (FIG. 1). For example, a lower ranked grid point may be merged with a location of a higher ranked neighboring (adjacent) grid point if neighbors of the lower ranked grid point are within a line of sight (e.g., not route obstructed by a feature in a diagram).

In another example, ranked nodes (grid points) may be inserted into a list and sorted by rank (primary and/or secondary) for use in a reduction process. For example, certain ranked lists may be arranged in a descending sorted order from highest rank to lowest rank. A ranked list may, for example, allow for one or more (possibly iterative) reduction processes to be performed.

For example, for each ranked node in a list, one may attempt to perform a reduction as follows. A node “X” may be selected, e.g., based on rank order and considered for merging with another node. Here, for example, one may consider whether any of the neighboring nodes adjacent to node X, e.g. nodes Y₁, . . . Yₖ may be merged with or otherwise consumed by node X. Thus, for each neighbor of node X one may attempt to merge Yᵢ (one of X's neighboring adjacent nodes) with node X based on one or more rules.

Hence, by way of example, in certain implementations, the following rules for merging may be applied. For a node Y to be merged into a node X: (1) node X may need to have an unobstructed line of sight to all of node Y's direct neighbors; and (2) node X may have needed to have (previously) a direct line of sight to all nodes that node Y may have since consumed. Here, one may describe a list of nodes Y may have consumed as Y's “transparent” neighbors. Thus, if a node X is to consume a node Y, then all of node Y's transparent neighbors may also be merged with node X (e.g., appended to X's current transparent neighbors list). In addition, in accord with an example rule, a node Y may be merged into a node X provided, at least in part, that node X has a ranking (primary or secondary) that is greater than a ranking of node Y.

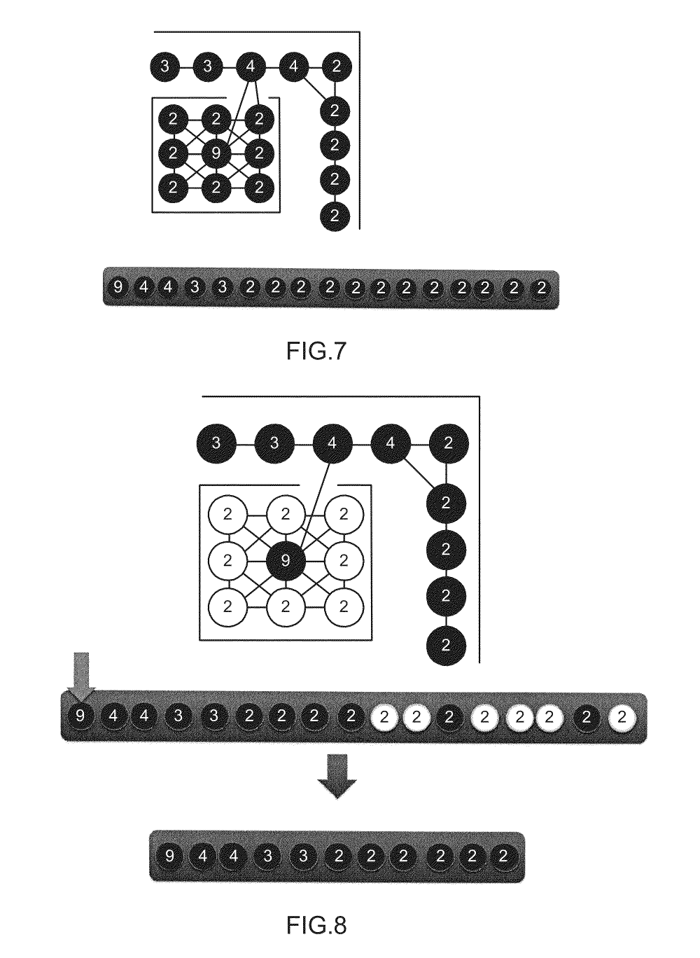

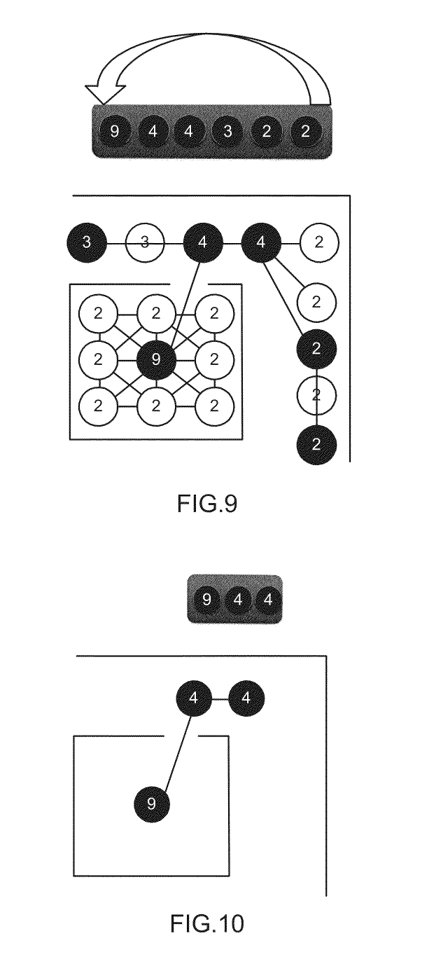

The above example reduction process is graphically illustrated in FIG. 7 through FIG. 10 as described below, which show a portion of a diagram of a structure having a plurality of grid points (nodes) assigned to locations. Here, each of the illustrated nodes is represented by a circle having a rank shown as an integer value. Adjacent or neighboring nodes are those illustrated as being interconnected by a line to a given node. In these illustrated examples, the initial set of nodes in FIG. 7 are reduced (iteratively) through selective merging in FIG. 8 and then FIG. 9, until in FIG. 10 there are no more nodes which may be merged according to the example rules applied. Hence, an initial set of eighteen nodes as shown in FIG. 7 may be reduced to a set of three nodes as shown in FIG. 10.

With this in mind, attention is drawn first to FIG. 7, wherein eighteen nodes are illustrated, nine of which are located within an interior room and nine of which are located in an hallway near by the interior room. Here, the interior room has an open entryway. Illustrated below the diagram and grid points (nodes) is a sorted ranking list that may be used in performing an iterative selective merging process.

As can be seen in FIG. 7, nodes in the interior room which are closest to a wall have a rank of “2” while a node in the center of the room (and at a distance greater from any wall in the room) is given a higher rank of “9.” In this example, the node with rank “9” is the first node in the sorted ranking list. Thus, in a first iteration of an example selective merging process, as illustrated in FIG. 8, the node with rank “9” may be considered the node X, and neighboring nodes having a rank of “2” may be consider nodes Y₁, . . . Yₖ. Hence, applying the example rules above, the neighboring nodes having a rank of “2” may be merged with the node with rank “9”. The node with rank “9” may then be connected by an edge with a grid point out side of the room (e.g., in a hallway) having a rank of “4.” Here, for example, the lightened or gray nodes in FIG. 8 having been consumed may considered as transparent neighbors of the node with rank “9.” Hence, as illustrated the sorted list may be reduced. Once all possible neighbor nodes for the node with rank “9” have been consumed, the selective merging process may continue with a next highest ranked node in the sorted list (e.g., a node with rank “4”), and so on.

Thus, as shown in FIG. 9, there may be significantly fewer nodes once the example selective merging process has made its first pass through the sorted list of nodes. Here, for example, there are only six nodes remaining which have not themselves been consumed through merger with another node. As illustrated by the arrow, having reached the end of the sorted list, the example selective merging process may continue (iterate) back to the beginning of the sorted list to possibly determine if still other merges may be performed.

In the present example, as illustrated by FIG. 10, the example selective merging process (after several iterations) has performed all possible mergers in accordance with the example rules that have been applied. As illustrated, there are only three nodes in the resulting reduced set.

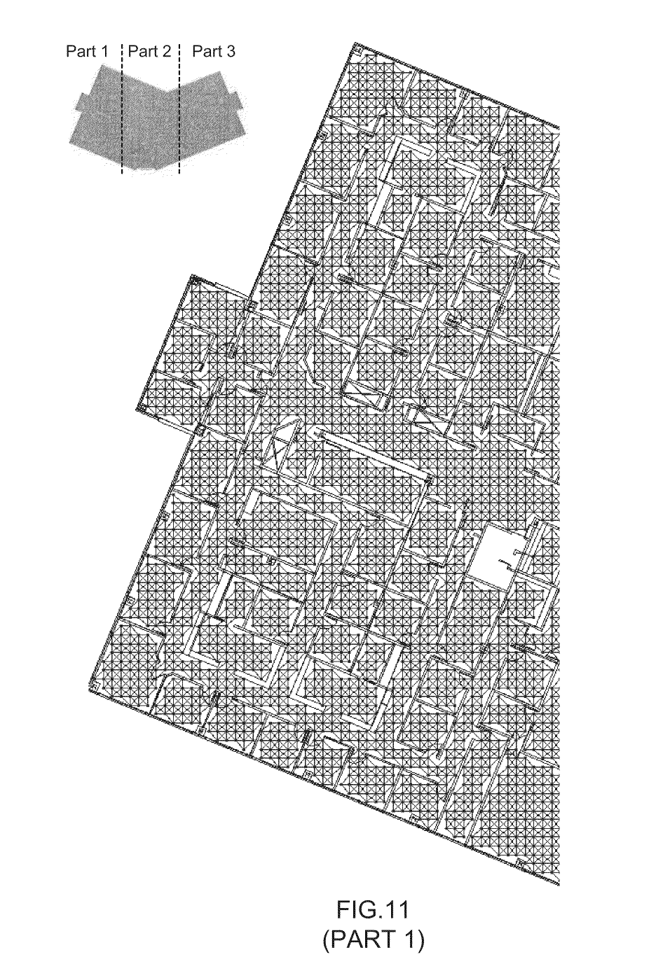

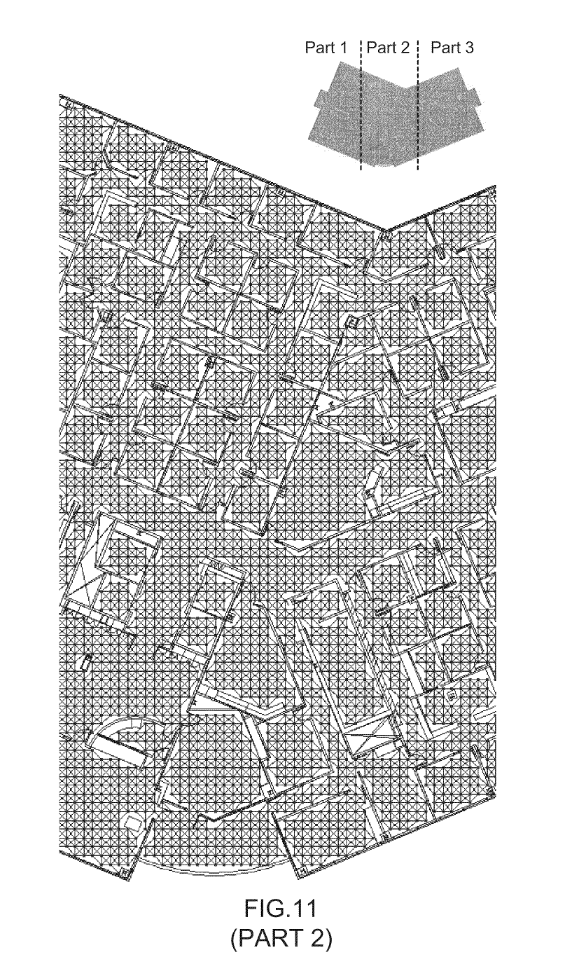

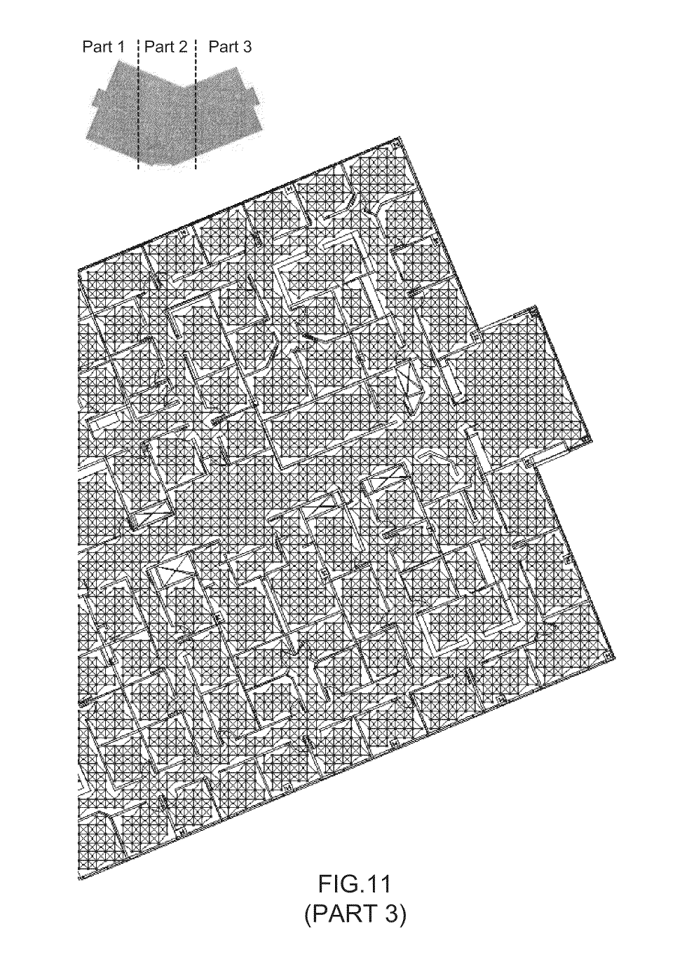

With the above example in mind, attention is drawn next to FIG. 11, in which a more realistic implementation example of a dense routeability graph connecting neighboring and unmerged grid points is illustrated. Here, a set of grid points has been assigned to locations in a diagram of a floor of a v-shaped office building. Here, by way of example, there are almost ten thousand nodes and almost thirty thousand interconnections or edges.

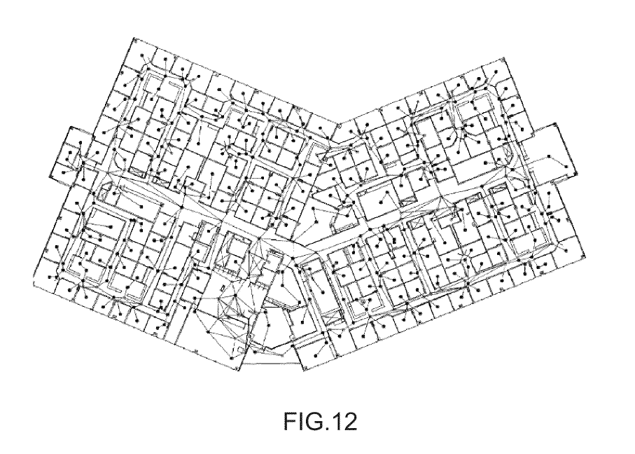

FIG. 12 is a detailed diagram as in FIG. 11, showing a reduced set of grid points for the same diagram following an example reduction process, in accordance with an example implementation. Here, by way of example, there are now less than five hundred nodes and less than six hundred interconnections or edges. This example reduced set of grid points (nodes) may, for example, be used to generate an encoded routeability graph description for this particular diagram.

As can be observed, a reduction in nodes and edges in an encoded routeability graph description may greatly reduce communication and/or computation requirements for certain mobile applications which employ a routeability graph (e.g., navigation operations). As illustrated in the example above, a deterministic process may be used to substantially reduce a dense analysis graph of a given structure to a compact efficient encoded routeability graph description that may be more easily transmitted, stored and/or processed by a computing device and/or a mobile device.

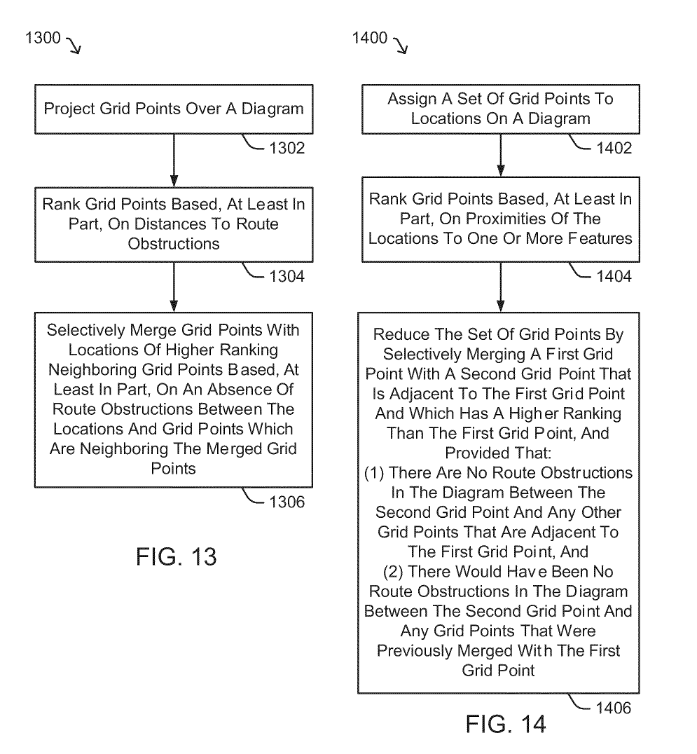

Reference is made next to FIG. 13, which is a flow diagram illustrating an example method 1300 that may be implemented in whole or part in with a computing device (e.g., via apparatus 104) and/or with a mobile device (e.g., via apparatus 108) to generate all or part of an encoded routeability graph description 116 (FIG. 1), in accordance with an implementation.

At block 1302, for example, grid points may be projected over a diagram of an indoor area. A diagram may, for example, indicate at least some route obstructions in the indoor area.

At block 1304, for example, grid points may be ranked. For example, grid points may be ranked on distances to route obstructions. In certain example implementations, ranking grid points may further comprise determining distances along axes through at least one of the grid points, and ranking the grid point based, at least in part, on a shortest distance along an axis to a route obstruction. In certain instances, distances may be determined as an integer number of grid point hops along a path of an axis.

At block 1306, for example, grid points may be selectively merged with locations of higher ranking neighboring grid points based, at least in part, on an absence of route obstructions between the locations and grid points which are neighboring the merged grid points. In certain example implementations, a reduced encoded routeability graph description may be generated once all applicable grid points have been merged. In certain instances, method 1300 may also further comprises connecting remaining neighboring un-merged grid points as nodes in a reduced encoded routeability graph description.

Reference is made next to FIG. 14, which is a flow diagram illustrating another example method 1400 that may be implemented in whole or part in with a computing device (e.g., via apparatus 104) and/or with a mobile device (e.g., via apparatus 108) to generate all or part of an encoded routeability graph description 116 (FIG. 1), in accordance with an implementation.

At block 1402, for example, a set of grid points may be assigned to locations on a diagram, wherein at least a portion of the diagram is indicative of at least one feature within a portion of a structure.

At block 1404, for example, at least a portion of the grid points may be ranked based, at least in part, on proximities of the locations to the feature.

At block 1406, for example, the set of grid points may be reduced by selectively merging a first grid point with a second grid point that is adjacent to the first grid point and which has a higher ranking than the first grid point and provided that: (1) there are no route obstructions in said diagram between said second grid point and any other grid points that are adjacent to said first grid point, and (2) there would have been no route obstructions in said diagram between said second grid point and any grid points that were previously merged with said first grid point. In certain example instances, by selectively merging a first grid point with a second gird point, the second grid point inherits any grid points that were previously merged with the first grid point.

In certain example instances, method 1400 may further comprise generating an encoded routeability graph description based, at least in part, on at least a portion of the reduced set of grid points.

Reference throughout this specification to “one example”, “an example”, “certain examples”, or “example implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information (e.g., as representative data). It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method of generating an encoded routeability graph description, the method comprising:
projecting grid points over a diagram of an indoor area, said diagram indicating at least some route obstructions in said indoor area;
ranking said grid points based, at least in part, on distances between said grid points and said route obstructions; and
selectively merging grid points with locations of higher ranking neighboring grid points based, at least in part, on an absence of route obstructions between the locations and grid points which are neighboring said merged grid points.

2. The method as recited in claim 1, wherein said ranking said grid points further comprises:
determining distances along axes through at least one of said grid points; and
ranking said at least one of said grid points based, at least in part, on a shortest distance along said axes to at least one of said route obstructions.

3. The method as recited in claim 2, wherein said distances are determined as an integer number of grid point hops along said axes.

4. The method as recited in claim 1, and further comprising:
following said selectively merging said grid points, selectively merging remaining un-merged grid points with locations of neighboring un-merged grid points having a higher rank, at least in part, in the absence of route obstructions between the locations of said neighboring un-merged grid points neighboring said un-merged grid points to be merged.

5. The method as recited in claim 1, wherein said generating said reduced encoded routeability graph description further comprises connecting remaining neighboring un-merged grid points as nodes in said encoded routeability graph description.

6. A method comprising:
with a computing device:
assigning a set of grid points to locations on a diagram, wherein at least a portion of said diagram is indicative of at least one feature within a portion of a structure;
ranking at least a portion of said grid points based, at least in part, on proximities of said locations to said at least one feature; and
reducing said set of grid points by selectively merging a first grid point with a second grid point that is adjacent to said first grid point and which has a higher ranking than said first grid point, and provided that:
(1) there are no route obstructions in said diagram between said second grid point and any other grid points that are adjacent to said first grid point, and
(2) there would have been no route obstructions in said diagram between said second grid point and any grid points that were previously merged with said first grid point.

7. The method as recited in claim 6, wherein, by selectively merging said first grid point with said second gird point, said second grid point inherits said any grid points that were previously merged with said first grid point.

8. The method as recited in claim 6, where said reducing said set of grid points is performed iteratively beginning with a highest ranked grid point.

9. The method as recited in claim 6, where said reducing said set of grid points is performed iteratively until there are no further grid points available to be selectively merged.

10. The method as recited in claim 6, and further comprising:
generating an encoded routeability graph description based, at least in part, on at least a portion of said reduced set of grid points.

11. An apparatus for use in generating an encoded routeability graph description, the apparatus comprising:
means for projecting grid points over a diagram of an indoor area, said diagram indicating at least some route obstructions in said indoor area;
means for ranking said grid points based, at least in part, on distances between said grid points and said route obstructions; and
means for selectively merging grid points with locations of higher ranking neighboring grid points based, at least in part, on an absence of route obstructions between the locations and grid points which are neighboring said merged grid points.

12. The apparatus as recited in claim 11, and said means for ranking said grid points further comprises:
means for determining distances along axes through at least one of said grid points; and
means for ranking said at least one of said grid points based, at least in part, on a shortest distance along said axes to at least one of said route obstructions.

13. The apparatus as recited in claim 12, wherein said distances are determined as an integer number of grid point hops along said axes.

14. The apparatus as recited in claim 11, and further comprising:
means for selectively merging remaining un-merged grid points with locations of neighboring un-merged grid points having a higher rank, at least in part, in the absence of route obstructions between the locations of said neighboring un-merged grid points neighboring said un-merged grid points to be merged.

15. The apparatus as recited in claim 11, wherein said means for generating said encoded routeability graph description further comprises:
means for connecting remaining neighboring un-merged grid points as nodes in said encoded routeability graph description.

16. An apparatus for use in a computing device, the apparatus comprising:
means for assigning a set of grid points to locations on a diagram, wherein at least a portion of said diagram is indicative of at least one feature within a portion of a structure;
means for ranking at least a portion of said grid points based, at least in part, on proximities of said locations to said at least one feature; and
means for reducing said set of grid points by selectively merging a first grid point with a second grid point that is adjacent to said first grid point and which has a higher ranking than said first grid point, and provided that:
(1) there are no route obstructions in said diagram between said second grid point and any other grid points that are adjacent to said first grid point, and
(2) there would have been no route obstructions in said diagram between said second grid point and any grid points that were previously merged with said first grid point.

17. The apparatus as recited in claim 16, wherein, by selectively merging said first grid point with said second gird point, said second grid point inherits said any grid points that were previously merged with said first grid point.

18. The apparatus as recited in claim 16, where said means for reducing said set of grid points is performed iteratively beginning with a highest ranked grid point.

19. The apparatus as recited in claim 16, where said means for reducing said set of grid points is performed iteratively until there are no further grid points available to be selectively merged.

20. The apparatus as recited in claim 16, and further comprising:
means for generating an encoded routeability graph description based, at least in part, on at least a portion of said reduced set of grid points.

21. A device for generating an encoded routeability graph description, the device comprising:
memory; and
a processing unit to: project grid points over a diagram of an indoor area, said diagram indicating at least some route obstructions in said indoor area; rank said grid points based, at least in part, on distances between said grid points and said route obstructions; and selectively merge grid points with locations of higher ranking neighboring grid points based, at least in part, on an absence of route obstructions between the locations and grid points which are neighboring said merged grid points.

22. The device as recited in claim 21, said processing unit to further:
determine distances along axes through at least one of said grid points; and
rank said at least one of said grid points based, at least in part, on a shortest distance along said axes to at least one of said route obstructions.

23. The device as recited in claim 22, wherein said distances are determined as an integer number of grid point hops along said axes.

24. The device as recited in claim 21, said processing unit to further, following said selectively merging said grid points, selectively merge remaining un-merged grid points with locations of neighboring un-merged grid points having a higher rank, at least in part, in the absence of route obstructions between the locations of said neighboring un-merged grid points neighboring said un-merged grid points to be merged.

25. The device as recited in claim 21, said processing unit to further connect remaining neighboring un-merged grid points as nodes in said encoded routeability graph description.

26. The device as recited in claim 21, said processing unit to further generate said encoded routeability graph description for storage in said memory.

27. A device comprising:
memory; and
a processing unit to: assign a set of grid points to locations on a diagram, wherein at least a portion of said diagram is indicative of at least one feature within a portion of a structure; rank at least a portion of said grid points based, at least in part, on proximities of said locations to said at least one feature; and reduce said set of grid points by selectively merging a first grid point with a second grid point that is adjacent to said first grid point and which has a higher ranking than said first grid point, and provided that:
(1) there are no route obstructions in said diagram between said second grid point and any other grid points that are adjacent to said first grid point, and
(2) there would have been no route obstructions in said diagram between said second grid point and any grid points that were previously merged with said first grid point.

28. The device as recited in claim 27, wherein, by selectively merging said first grid point with said second gird point, said second grid point inherits said any grid points that were previously merged with said first grid point.

29. The device as recited in claim 27, said processing unit to further reduce said set of grid points iteratively beginning with a highest ranked grid point.

30. The device as recited in claim 27, said processing unit to further reduce said set of grid points iteratively until there are no further grid points available to be selectively merged.

31. The device as recited in claim 27, said processing unit to further:
generate an encoded routeability graph description for storage in said memory based, at least in part, on at least a portion of said reduced set of grid points.

32. An article for use in generating an encoded routeability graph description, the article comprising:
a non-transitory computer readable medium having stored therein computer implementable instructions executable by a processing unit to:
project grid points over a diagram of an indoor area, said diagram indicating at least some route obstructions in said indoor area;
rank said grid points based, at least in part, on distances between said grid points and said route obstructions; and
selectively merge grid points with locations of higher ranking neighboring grid points based, at least in part, on an absence of route obstructions between the locations and grid points which are neighboring said merged grid points.

33. The article as recited in claim 32, said computer implementable instructions being further executable by said processing unit to: determine distances along axes through at least one of said grid points; and rank said at least one of said grid points based, at least in part, on a shortest distance along said axes to at least one of said route obstructions.

34. The article as recited in claim 33, wherein said distances are determined as an integer number of grid point hops along said axes.

35. The article as recited in claim 32, said computer implementable instructions being further executable by said processing unit to, following said selectively merging said grid points, selectively merge remaining un-merged grid points with locations of neighboring un-merged grid points having a higher rank, at least in part, in the absence of route obstructions between the locations of said neighboring un-merged grid points neighboring said un-merged grid points to be merged.

36. The article as recited in claim 32, said computer implementable instructions being further executable by said processing unit to connect remaining neighboring un-merged grid points as nodes in said encoded routeability graph description.

37. An article comprising:
a non-transitory computer readable medium having stored therein computer implementable instructions executable by a processing unit to:
assign a set of grid points to locations on a diagram, wherein at least a portion of said diagram is indicative of at least one feature within a portion of a structure;
rank at least a portion of said grid points based, at least in part, on proximities of said locations to said at least one feature; and
reduce said set of grid points by selectively merging a first grid point with a second grid point that is adjacent to said first grid point and which has a higher ranking than said first grid point, and provided that:
(1) there are no route obstructions in said diagram between said second grid point and any other grid points that are adjacent to said first grid point, and
(2) there would have been no route obstructions in said diagram between said second grid point and any grid points that were previously merged with said first grid point.

38. The device as recited in claim 37, wherein, by selectively merging said first grid point with said second gird point, said second grid point inherits said any grid points that were previously merged with said first grid point.

39. The device as recited in claim 37, said computer implementable instructions being further executable by said processing unit to reduce said set of grid points iteratively beginning with a highest ranked grid point.

40. The device as recited in claim 37, said computer implementable instructions being further executable by said processing unit to reduce said set of grid points iteratively until there are no further grid points available to be selectively merged.

41. The device as recited in claim 37, said computer implementable instructions being further executable by said processing unit to generate an encoded routeability graph description based, at least in part, on at least a portion of said reduced set of grid points.
